(19) United States
(12) Patent Application Publication
(10) Pub. No.: US 2026/0105794 A1
(43) Pub. Date: Apr. 16, 2026

(54) FACIAL RECOGNITION LOCKER BANK

(71) Applicant: Smarte Carte, Inc., St. Paul, MN (US)

(72) Inventors: Daniel Foreman, Lino Lakes, MN (US); Kong Vang, Circle Pines, MN (US)

(21) Appl. No.: 19/356,694

(22) Filed: Oct. 13, 2025

Related U.S. Application Data
(60) Provisional application No. 63/706,823, filed on Oct. 14, 2024.

(51) Int. Cl. G07C 9/00; G06V 40/16; G06V 40/50

(52) U.S. Cl. CPC G07C 9/00563; G06V 40/166; G06V 40/172; G06V 40/50; G07C 9/00182; G07C 9/00571; G07C 9/00817; G07C 9/00896; G07C 2009/00238; G07C 2209/12

(57) ABSTRACT

A facial recognition locker bank is provided. In an example, the facial recognition locker bank captures an image of a user renting a locker at the locker bank. A vector may be computed based on the image, and the vector is used for facial recognition. The vector may be shared with other associated locker banks over a local area network so that the other locker banks can identify the user. For example, the other locker banks may identify the user and direct the user to the locker bank at which the user rented the locker. When the user returns to the locker bank, a second image of the user is captured, and a second vector is computed. Based on a comparison between the vectors, the user can be identified, and the rented locker can be unlocked.

### CROSS-REFERENCE TO RELATED APPLICATIONS

This application claims priority to U.S. Provisional Patent Application No. 63/706,823 filed Oct. 14, 2024, the disclosure of which is incorporated herein by reference in its entirety.

### BACKGROUND

Rental lockers may be used in many locations for users to temporarily store items. Some rentals are for a single-entry use and others for multiple-entry use. For example, at an amusement park, users may choose to, or may be required to, store large items and loose items in lockers before riding an amusement park ride. A user in a waterpark may rent a locker to store items periodically throughout the day with multiple re-entries. In an airport, users may choose to store luggage or backpacks for multiple days. To prevent the stored items from being stolen, the rental lockers may include a lock that is unlockable with a unique ID, key or a passcode. However, users may lose the unique ID or key, or they may forget the passcode, and then be unable to retrieve their stored items.

### SUMMARY

In general terms, this disclosure is directed to a facial recognition locker bank. In some embodiments, and by non-limiting example, the facial recognition locker bank uses facial recognition to identify users and control access to rented lockers. In examples, locker banks may share data with other associated locker banks so that each locker bank can recognize registered users.

In a first aspect, a facial recognition locker bank is provided. The facial recognition locker bank comprises one or more lockers, a camera, one or more processors, and one or more local computer-readable storage devices storing data instructions. The data instructions, when executed by the one or more processors, cause the facial recognition locker bank to capture a first image of a user, compute a first vector based on the first image, generate an association between the first vector and a locker of the one or more lockers, store the association between the first vector and the locker of the one or more lockers, transmit the first vector to one or more associated locker banks, capture a second image of the user, compute a second vector based on the second image, compare the second vector to the first vector, and based on the comparison, unlock the locker associated with the first vector. The first and second images are captured by the camera and include a face of the user. The association between the first vector and the locker of the one or more lockers is stored in the one or more local computer-readable storage devices.

In a second aspect, a method for operating a facial recognition locker bank is provided. A first image of a user is captured with a camera of a locker bank. The image includes a face of the user. A first vector is computed based on the first image. An association between the first vector and a locker of the locker bank is generated and stored in a local memory of the locker bank. The first vector is transmitted to one or more associated locker banks. A second image of the user is captured with the camera. The second image includes the face of the user. A second vector is computed based on the second image. The second vector is compared to the first vector. Based on the comparison, the locker associated with the first vector is unlocked.

In a third aspect, a facial recognition locker bank is provided. The facial recognition locker bank comprises one or more lockers, a camera, one or more processors, and one or more local computer-readable storage devices storing data instructions. The data instructions, when executed by the one or more processors, cause the facial recognition locker bank to receive a first image of a user from a computing device of the user, compute a first vector based on the first image, generate an association between the first vector and a locker of the one or more lockers, store the association between the first vector and the locker of the one or more lockers, transmit the first vector to one or more associated locker banks, capture a second image of the user with the camera, compute a second vector based on the second image, compare the second vector to the first vector, and based on the comparison, unlock the locker associated with the first vector. The first and second images include a face of the user. The association between the first vector and the locker of the one or more lockers is stored in the one or more local computer-readable storage devices.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1A illustrates an example of a user renting a locker at a facial recognition locker bank.

FIG. 1B illustrates an example of a user attempting to retrieve items from a facial recognition locker bank at which the user does not have a locker rented.

FIG. 1C illustrates an example of a user retrieving items from a facial recognition locker bank.

FIG. 2 illustrates an example embodiment of a facial recognition locker bank.

FIG. 3 illustrates an example environment in which a facial recognition locker bank may be used.

FIG. 4 illustrates example memories of a plurality of facial recognition locker banks in an environment.

FIG. 5 illustrates an example of a user redeeming a reservation at a facial recognition locker bank.

FIG. 6 illustrates an example of a reservation user interface in a locker application.

FIG. 7 illustrates an example of a confirmation user interface in a locker application.

FIG. 8 illustrates a flowchart of an example method for operating a facial recognition locker bank.

FIG. 9 illustrates a flowchart of another example method for operating a facial recognition locker bank.

FIG. 10 illustrates a flowchart of a further example method for operating a facial recognition locker bank.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, embodiments of the present disclosure are directed to a facial recognition locker bank. In example aspects, a locker bank includes a camera for capturing an image of a user's face during a registration process in which the user rents a locker. When the user returns to the locker bank to retrieve items stored in the rented locker, the locker bank captures a second image of the user's face. Based on a comparison between the first and second images of the user's face, the locker bank may identify the user and automatically unlock the locker rented by the user.

In example aspects, the locker bank may be connected with one or more other locker banks across an environment via a local area network. The locker banks may share data with each other across the local area network, allowing the locker bank to identify users that registered at one of the other locker banks. By sharing information via the local area network, the locker banks in the environment can operate without relying on a central server or a data center. Because the locker banks in the environment do not rely on the central server, the locker banks can operate when a connection to the central server is not available (e.g., during a network outage). Similarly, the locker banks can operate in environments that do not include a central server.

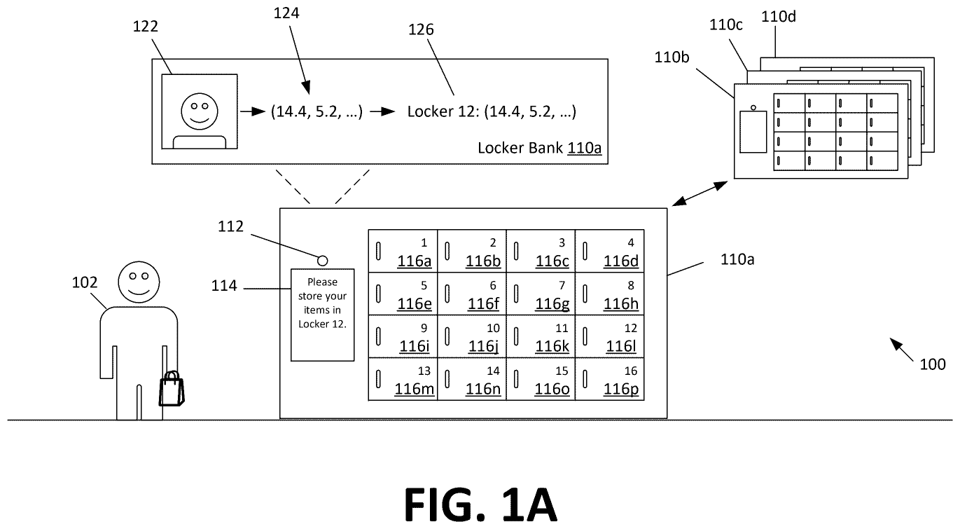

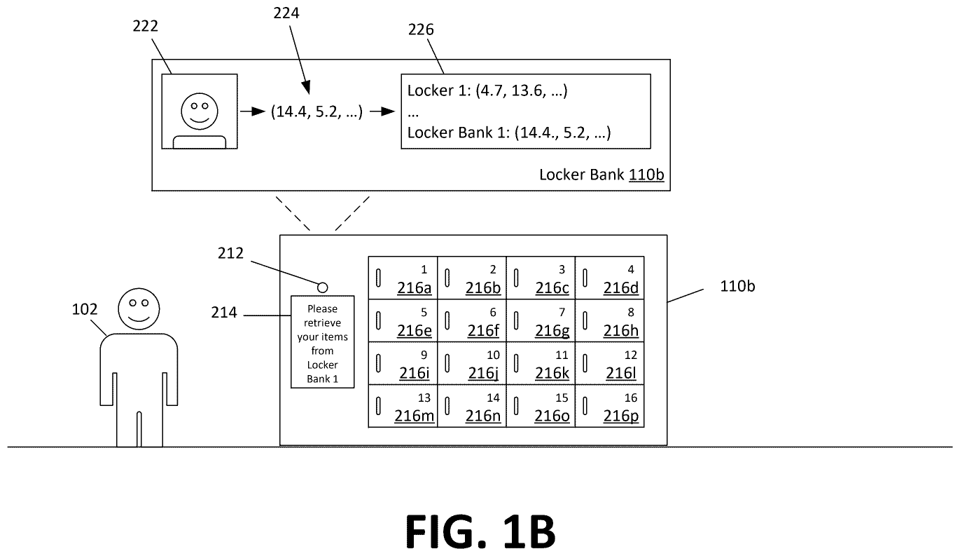

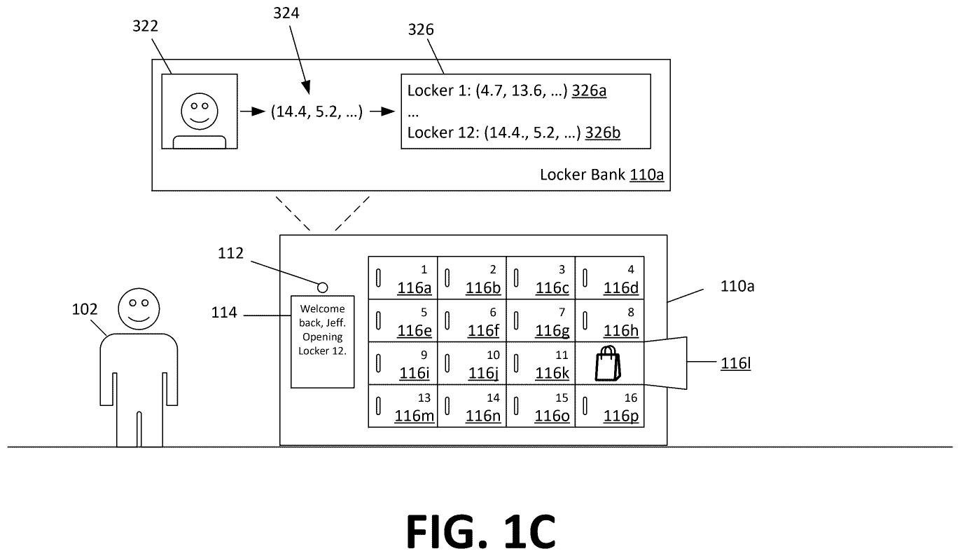

Turning now to FIGS. 1A-C, an example facial recognition locker system 100 is shown. In the illustrated embodiment, the system 100 includes a locker bank 110a connected to one or more other locker banks 110b-d. In embodiments, each locker bank 110 includes a camera 112, 212, a display 114, 214, and a plurality of lockers 116, 216 that can be rented to users 102. In some embodiments, the locker bank 110a is connected to the other locker banks 110b-d over a local area network.

While the illustrated embodiment shows one camera 112, 212 and one display 114, 214 on the locker banks 110, in alternative embodiments, the locker banks 110 may include one or more additional cameras 112, 212 and one or more additional displays 114, 214. For example, a first side of the locker bank 110a may be used for registration and rental while a second side of the locker bank 110a may be used to retrieve items from rented lockers. Accordingly, in this example, both the first side and the second side of the locker bank 110a may include a camera 112 and a display 114. In further examples, a side of the locker bank 110a may include multiple cameras 112 and multiple displays 114.

FIG. 1A illustrates an example of a user 102 renting a locker 116 at the locker bank 110a. In an example, the user 102 may interact with the display 114 to initiate a registration process to rent the locker 116. In examples, the user 102 may rent the locker 116 for a designated time period. For example, the user 102 may rent the locker 116 for two hours or from 1:00 to 4:00. In alternative examples, the user 102 may rent the locker 116 for a single use (e.g., once the user 102 unlocks the locker 116 to retrieve items stored in the locker 116, the rental ends). In further examples, the user 102 may rent the locker 116 until the user 102 manually ends the rental. For example, the user 102 may interact with the display 114 to end the rental. In some embodiments, the user 102 may rent the locker for multiple days, such as by designating a time period across multiple days during the initial registration process or by manually ending the rental after multiple days of use.

During the registration process, an image 122 of the user 102 is captured by the camera 112 of the locker bank 110a. For example, the image 122 of the user 102 may include an image of the user's 102 face. In embodiments, the image 122 is vectorized by the locker bank 110a. As described further herein, the vector 124 of the image 122 is a numerical representation of the image 122 that can be used to compare images for facial recognition. In some embodiments, the image 122 and the vector 124 may be encrypted by the locker bank 110a. By encrypting the image 122 and the vector 124, personal identifiable information about the user 102 is protected.

After the image 122 is captured and vectorized, the locker bank 110a assigns a locker 116l to the user 102, and the user can store items in the rented locker 116l. The locker bank 110a unlocks the locker 116l to allow the user 102 to access the locker 116l. The locker bank 110a relocks the locker 116l after the user 102 stores the items. For example, when a door to the locker 116l is closed, the locker bank 102a may lock the locker 116l.

In embodiments, the locker bank 110a stores a mapping 126 between the image 122, the vector 124, and the locker 116l in a memory. As described herein, the mapping may be used when the user 102 returns to the locker bank 110a to retrieve the stored items.

In embodiments, the locker bank 110a shares the vector 124 with the one or more other locker banks 110b-d. By sharing the vector 124 with the other locker banks 110b-d, the other locker banks 110b-d can identify the user 102. For example, users 102 may be prevented from renting lockers 116 at multiple locker banks 110, so the other locker banks 110b-d may be informed of the registration at the locker banks 110a and prevent the user 102 from renting another locker 116 at one of the other locker banks 110b-d. In another example, because the other locker banks 110b-d can identify the user 102, the other locker banks 110b-d can help guide the user 102 to the locker bank 110a to retrieve the stored items if the user 102 incorrectly attempts to retrieve the stored items from one of the other locker banks 110b-d.

In some embodiments, the locker bank 110a does not share the image 122 with the other locker banks 110b-d. By limiting access to the image 122 to the locker bank 110a and not sharing the image 122 over the local area network, the image 122 is better protected and less likely to be accessed by malicious actors.

Further because the images 122 and vectors 124 are managed locally by the locker banks 110 rather than maintaining the images 122 and vectors 124 in a central server or a data center, the images 122 and vectors 124 are better protected from malicious actors. For example, a malicious actor cannot access a central server or data center and get the images for all users who have registered with the locker banks 110.

FIG. 1B illustrates an example of the user 102 attempting to retrieve the stored items from one of the other locker banks 110b-d. For example, as described above in connection with FIG. 1A, the user 102 may rent a locker 116l at the locker bank 110a. Accordingly, the user 102 may not have a locker 216 rented at the locker bank 110b.

Because the locker banks 110 share information to identify users 102 that have registered at one of the locker banks 110 (e.g., the locker banks 110 may share vectors 124 of registered users 102), even though the user 102 did not rent a locker at the locker bank 110b, the locker bank 110b may still identify the user 102.

Similar to the registration process, the locker bank 110b may capture an image 222 of the user 102 (e.g., an image of the user's 102 face) using the camera 212. In an example, the image of the user 102 may be captured automatically as the user 102 approaches the locker bank 110b. In an alternative example, the user 102 may interact with the display 214 of the locker bank 110b to initiate a process to retrieve items from a locker 216, and the image may be captured during the item retrieval process.

The locker bank 110b may vectorize the image 222 and compare the computed vector 224 to vectors in stored mappings 226 to determine if the user 102 matches a registered user. In this example, the locker bank 110b may determine that the user 102 matches a user registered at the locker bank 110a based on the computed vector 224 matching a vector in the mappings 226 received from the locker bank 110a. After identifying the user 102, the locker bank 110b may present information on the display 214 to direct the user 102 to the locker bank 110a at which the user 102 rented the locker 116l.

In some embodiments, users 102 may be prevented from renting multiple lockers 116, 216 at the same time. For example, the locker bank 110b may identify that the user 102 has a locker 116l rented at the locker bank 110a and prevent the user 102 from renting a locker 216 at the locker bank 110b.

FIG. 1C illustrates an example of the 102 retrieving the stored items from the locker bank 110a at which the items are stored. Like the example described in connection with FIG. 1B, as the user 102 approaches the locker bank 110a, the camera 112 may capture an image 322 of the user 102, and the image 324 may be vectorized for facial recognition. In another embodiment, the image may be captured after the user 102 interacts with the display 114 to initiate an item retrieval process.

In this example, the locker bank 110a identifies that the user 102 matches a registered user based on the vectors in the stored mappings 326, and the locker bank 110a uses stored mappings 326 between the vectors and the lockers 116 to identify that the user 102 has rented the locker 116l. Accordingly, the locker bank 110a may unlock the locker 116l so that the user 102 can retrieve the stored items. In embodiments, the locker bank 110a relocks the locker 116l after the user 102 retrieves the stored items. For example, the locker bank 110a may lock the locker 116l after a door to the locker 116l is closed.

After the user 102 retrieves the stored items, the locker bank 110a may delete the data associated with the user 102. For example, the locker bank 110a may delete the stored image, vector, and corresponding mapping 326b to the locker 116l. The locker bank 110a may also notify the other locker banks 110b-d that the user 102 has retrieved the stored items so that the other locker banks 110b-d can delete the saved data about the user 102 (i.e., the vector shared by the locker bank 110a).

In some embodiments, the data associated with the user 102 is deleted immediately after the user 102 retrieves the stored items. For example, after the door to the locker 116l is closed, the locker bank 110a may delete the image, vector, and corresponding mapping 326b to the locker 116l. In other embodiments, the locker banks 110 may save the data for a buffer period (e.g., 1 hour) after the user retrieves the stored items. In an example, the user 102 may accidentally leave an item in the locker 116l. By maintaining the data for the buffer period, the user 102 may have an opportunity to return to the locker bank 110a to retrieve items that were accidentally left behind. Further, in some embodiments, the data may additionally or alternatively be deleted at designated times. For example, the locker banks 110 may be programmed to delete the data daily (e.g., at the end of the day) or after multiple days.

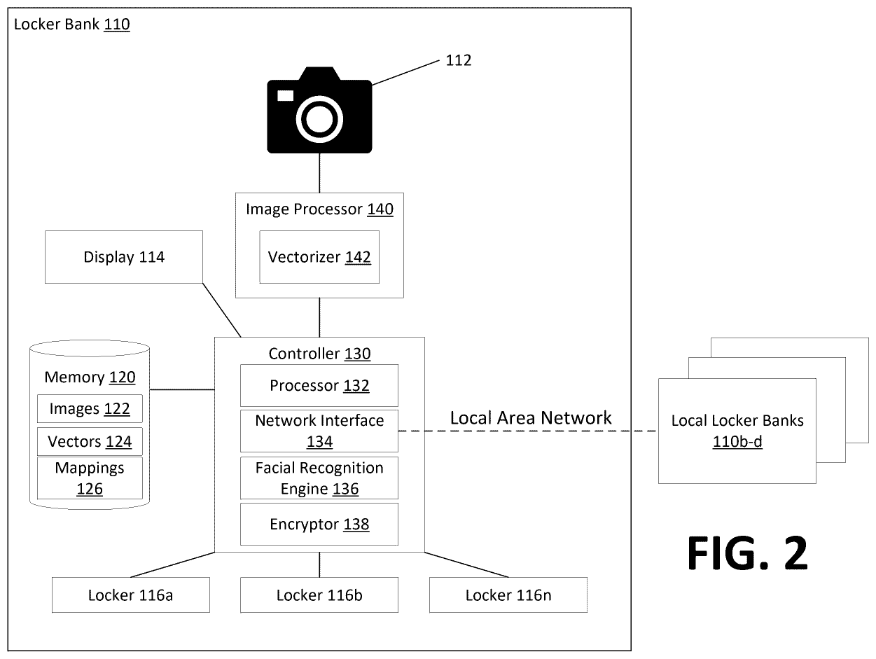

Turning to FIG. 2, an example embodiment of a locker bank 110a is shown. In the illustrated embodiment, the locker bank 110a includes a camera 112, a display 114, an image processor 140, a controller 130, a memory 120, and one or more lockers 116.

The controller 130 controls the locker bank 110a. In embodiments, the controller 130 includes one or more processors 132 that execute data instructions stored in the memory 120 to perform registration and retrieval processes. As described herein, the locker bank 110a allows for facial recognition to be used to identify users that have items stored in the lockers 116 of the locker bank 110a.

The display 114 presents information to users interacting with the locker bank 110a. In embodiments, the display 114 may also act as an input device for the locker bank 110a. For example, the display 114 may be a touch screen display, allowing users to interact with the display 114 to input information. In alternative embodiments, the locker bank 110a may include an input device separate from the display 114, such as a keyboard.

In embodiments, as described above, a user may interact with the display 114 to initiate a registration process to rent a locker 116 at the locker bank 110a. Similarly, the user may interact with the display 114 to initiate an item retrieval process to retrieve items stored in the rented locker 116.

Users may also interact with the display 114 to input information during these processes. For example, users may use the display 114 to input payment information during the registration process. Alternatively, separate components may be used to receive payment information from users, such as a credit card reader. In another example, the display 114 may be used by users during the item retrieval process input a passcode for identification, as described further herein. In further examples, an image reader may be used for barcode/QR code identification, or an RFID reader may be used for RFID code identification.

As described above, the camera 112 captures images of users for facial recognition. While the illustrated embodiment shows one camera 112, in alternative embodiments, the locker bank 110a may include a plurality of cameras. For example, as described above, the locker bank 110a may include a first side for registration and item storage and a second side for item retrieval. In this example, the locker bank 110a may include one or more cameras 112 on the first side and one or more cameras 112 on the second side.

In some embodiments, in addition to the images captured by the camera 112 being used for facial recognition, the images may also be used for liveness detection to prevent presentation attacks (e.g., a malicious actor presenting an image of a user at the locker bank to access a locker rented by the user). In an embodiment, the camera 112 may include additional sensors for liveness detection. For example, the camera 112 may include an infrared camera or a depth sensor such that the infrared image or the depth data can be used for liveness detection. In some embodiments, the camera 112 may include multiple lenses (or multiple cameras 112 may be used) so that images can be captured from multiple perspectives. In other embodiments, the camera 112 may be a three-dimensional (3D) camera, and 3D images may be captured by the camera 112 and used for liveness detection.

The images captured by the camera 112 are processed by the image processor 140. In an example, the image processor 140 prepares the image for facial recognition. For example, the image processor 140 may crop the image to a designated size or to center the user's face in the image.

In embodiments, the image processor 140 includes a vectorizer 142. The vectorizer 142 vectorizes the images captured by the camera 112, and the vectors are used by the facial recognition engine 136 during facial recognition. In an example, the vectorizer 142 generates a feature vector of the image 122. For example, the feature vector may include a height of the user's face, a width of the user's face, an average color of the face (in RGB colors), a width of the user's lips, and a height of the user's nose. In other examples, additional or alternative features may be extracted for the vector. In an embodiment, the vectorizer 142 includes a trained machine learning model for generating the vectors. For example, the vectorizer 142 may include a neural network model. In alternative embodiments, additional or alternative machine learning or statistical models may be used to generate the vectors from the images.

In the illustrated embodiment, the image processor 140 is illustrated as an individual component of the locker bank 110a. In alternative embodiments, the image processor may be included in one of the other components of the locker bank 110a. For example, in an embodiment, the camera 112 includes the image processor 140. In another example, the controller 130 includes the image processor 140.

The memory 120 may store information about users registered with the locker bank 110a or one of the other locker banks 110b-d. In embodiment, the memory 120 includes one or more computer-readable storage devices. In some embodiments, the one or more computer-readable storage devices include computer-readable media, such as computer-readable storage media and computer-readable communication media. Computer-readable storage media includes volatile and nonvolatile, removable and non-removable media implemented in any device configured to store information such as computer-readable instructions, data structures, program modules, or other data. Computer-readable storage media includes, but is not limited to, random access memory, read-only memory, electrically erasable programmable read-only memory, flash memory and other memory technology, compact disc read-only memory, blue ray discs, digital versatile discs or other optical storage, magnetic cassettes, magnetic tape, magnetic disk storage or other magnetic storage devices, or any other medium that can be accessed by the locker bank 110a. In some embodiments, computer-readable storage media is non-transitory computer-readable storage media.

During registration of a user, the vector 124 is stored in the memory 120. The controller 130 may assign a locker 116 to the user for the rental, and the memory 120 may include a mapping between the vector 124 and the locker 116. When the user comes to retrieve the stored items, the vector 124 is compared to the vectors 124 stored in the memory 120 to identity the user. The mappings 126 between the vectors 124 and the lockers 116 allows the locker bank 110a to determine which locker 116 to unlock for the user.

In some embodiments, the image 122 may additionally be stored in the memory 120. Although the vector 124 may be used during the facial recognition process, the image 122 may be stored as a backup. In the event that the facial recognition engine 136 or another component of the locker bank 110a malfunctions, the image 122 can be used by an administrator to manually recognize users so that the users' items do not remain locked in the lockers 116 if the locker bank 110a is not functioning properly.

In embodiments, the data stored in the memory 120 is encrypted to protect the images 122 and vectors 124 from malicious actors. In an example, the controller 130 includes an encryptor 138 that encrypts the images 122 and vectors that are stored in the memory 120. For example, encryption at rest may be used to protect the images 122 and vectors 124 stored in the memory 120. In an example, the Advanced Encryption Standard (AES-256) is used to encrypt the images 122 and vectors 124 stored in the memory 120.

As described above, during registration, the vectors 124 may be shared with other locker banks 110b-d. In an example, this allows the other locker banks 110b-d to identify the users that registered at the locker bank 110a so that the other locker banks 110b-d can direct the users to the locker bank 110aa to retrieve their stored items. In embodiments, a network interface 134 in the controller 130 is used for communications between locker banks 110 over a local area network.

To protect the vectors 124 during communication with the other locker banks 110b-d, the vectors 124 may be encrypted. For example, encryption in transit may be used to encrypt the vectors 124 during communications between the locker banks 110. In an example, Transport Layer Security (TLS) is used to encrypt the vectors 124 during communications between the locker banks 110.

As described above, the locker banks 110 may operate without needing to communicate images and vectors with a central server or a data center. However, in embodiments in which it is desirable to communicate with a central server or a data center, the network interface 134 may be configured to communicate with the central server or the data center. For example, the network interface may be used to communicate over a wide area network with the central server or the data center. As described further herein, the central server may be used to communicate locker reservations made by users in advance to the locker banks 110. In another example, the network interface 134 may be configured to communicate with third-party servers, such as a server to process payment information.

Once the vectors 124 are stored in the memory 120, the vectors 124 can be used to recognize users when the users return to retrieve items stored in the lockers 116. In an embodiment, the facial recognition engine 136 identifies the users retrieving items from the lockers 116. Similar to when a user registers with the locker bank 110a, the camera 112 captures an image of the user which is processed and vectorized by the image processor 140 and the vectorizer 142. The vector of the captured image can then be compared against the vectors 124 stored in the memory 120 to identify the user.

In an example, the facial recognition engine 136 compares the vector of the captured image to the vectors 124 stored in the memory 120 by calculating a cosine distance between the vector of the captured image and the vectors 124 stored in the memory 120. If the cosine distance is below a predetermined threshold, the facial recognition engine 136 determines that the vectors match and identifies the user. The controller 130 can then unlock the corresponding locker 116. In alternative embodiments, the facial recognition engine 136 may use any machine learning or statistical model to compare the vector of the captured image to the vectors 124 stored in the memory 120.

In embodiments, the locker bank 110a may be configured to rent lockers 116 without requiring facial recognition to unlock the lockers 116 to retrieve the stored items. In an example, a user may opt out of facial recognition and instead choose to use a different mechanism for identifying the user. Similarly, in some examples, users may need to opt in to facial recognition, and those users that do not opt in may use a different mechanism for identifying the users. Examples of different mechanisms that may be used to identify users include machine-readable codes (e.g., QR codes and barcodes) and passcodes. Further examples of different mechanisms that may be used to identify users include other biometric recognition, such as fingerprint recognition, and radio frequency identification (RFID) using RFID tags or other similar communication devices.

In an embodiment, the locker bank 110a may include a printer. In this embodiment, during registration, the printer may print a ticket including a machine-readable code that a user may use to access the rented locker 116. The memory 120 may store a mapping 126 between the machine-readable code and the rented locker 116. In an example, when the user returns to the locker bank 110a to retrieve the stored items, the user may present the machine-readable code on the ticket to the camera 112, and the camera 112 may capture an image of the machine-readable code. The locker bank 110a can then unlock the associated rented locker 116. In alternative embodiments, the locker bank 110a may include a scanner separate from the camera 112 to read the machine-readable codes.

In an alternative example, the locker bank 110a may communicate the machine-readable code to a mobile device of the user during registration. The user can then present the machine-readable code to the locker bank 110a using the mobile device. For example, the user may have a locker rental application installed on the mobile device that the user can use to present the machine-readable code. In an example, the locker bank 110a communicates directly with the mobile device, such as through the network interface 134 to share the machine-readable code. In another example, the locker bank 110a may communicate with a central server which then communicates with the user's mobile device to share the machine-readable code.

Similarly, in embodiments, a user may select to use a passcode to access the rented locker 116 during registration. Like with the vectors 124 and the machine-readable codes, a mapping 126 between the passcode and the rented locker 116 may be stored in the memory 120. When the user returns to retrieve items from the rented locker 116, the user may enter the passcode (e.g., through a touch interface on the display 114). If the passcode is correct, the locker bank 10 may unlock the locker 116, and the user can retrieve the stored items.

In some embodiments, multiple users may be registered with one locker 116. This may allow any of the multiple users to retrieve items from the locker 116. In an example, the memory 120 may store mappings 126 between each of the registered users and the rented locker 116. In an embodiment, facial recognition may be used to identify each of the registered users. In this embodiment, vectors 124 for each of the users are stored in the memory 120 and mapped to the rented locker 116. In another example embodiment, the users may choose different mechanisms for identification. For example, some users may choose facial recognition while others choose machine-readable codes or passcodes. In this embodiment, the memory 120 may store mappings 126 between a combination of vectors 124, machine-readable codes, and passcodes and the rented locker 116.

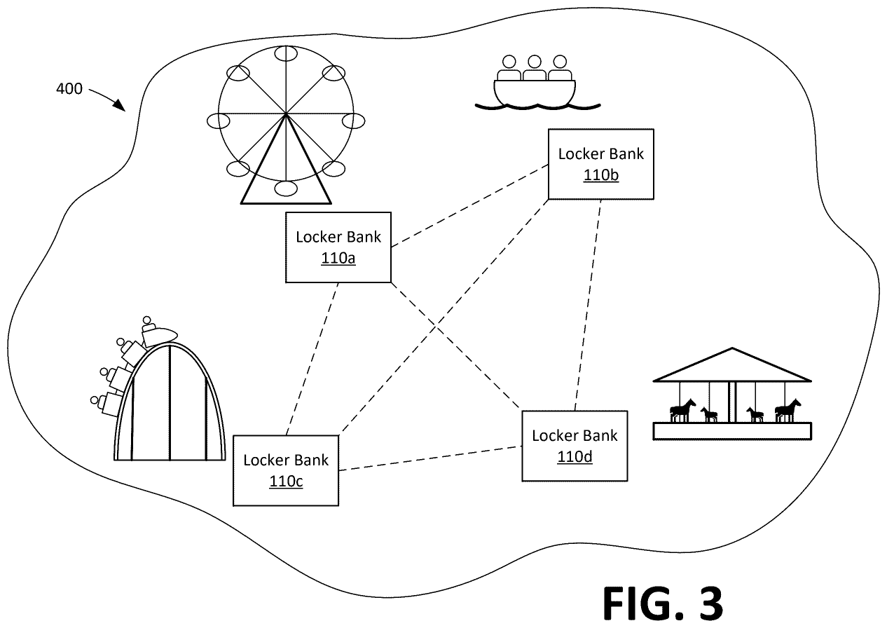

FIG. 3 illustrates an example environment 300 in which locker banks 110 may be used. In the illustrated example, an amusement park may include a plurality of locker banks 110. While the illustrated environment 300 is an amusement park, in alternative environments, the locker banks 110 may be used in any environment in which users store items, including water parks, event venues, fitness centers, airports, malls and offices.

In the illustrated example, the environment 300 includes four locker banks 110. As described above, users may register with the locker banks 110 to rent lockers to store items. During the registration process, the images of the users may be captured by the locker banks 110 and vectorized for facial recognition. The vectors may be shared by the locker banks 110 so that each locker bank 110 can identify the users. In embodiments, the locker banks 110 communicate over a local area network.

In an example, a user may rent a locker at a first locker bank 110a and may store items at the rented locker. The first locker bank 110a may capture an image of the user, vectorize the image, and share the vector with the other locker banks 110b-d. When the user wishes to retrieve the stored items, the user may accidentally attempt to retrieve the items from one of the other locker banks 110b. Because the user did not store items at the second locker bank 110b, the second locker bank 110b did not capture an image of the user during a registration process. However, the second locker bank 110b may still recognize the user because the first locker bank 110a shared a vector associated with the image of the user captured when the user rented the locker at the first locker bank 110a. In this example, the second locker bank 110b may recognize the user, identify that the user has a locker rented at the first locker bank 110a, and direct the user to the first locker bank 110a to retrieve the stored items.

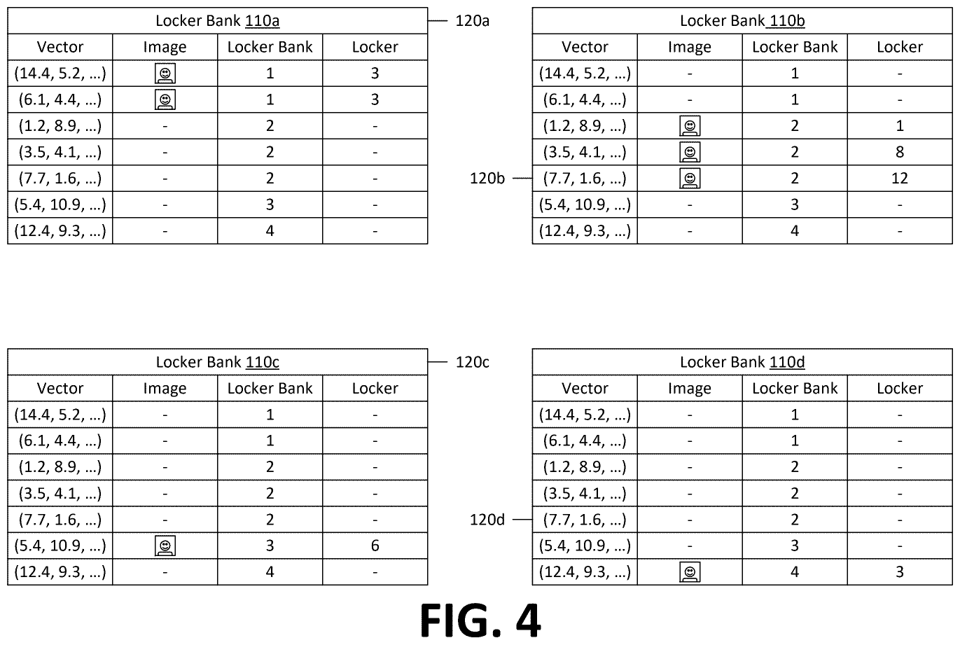

FIG. 4 illustrates an example of data stored in memories 120 of a plurality of locker banks 110 in an environment, such as the environment 300 illustrated in FIG. 3. In the illustrated embodiments, the memories 120 of the locker banks 110 maintain mappings between vectors and lockers. The memories 120 may also maintain images captured by the locker banks 110. Although not shown, the memories 120 may further maintain other information associated with locker rentals. For example, the memories 120 may store names of the users who rented the lockers and times of the rentals.

In the illustrated example, each of the memories 120 may store the vectors associated with users who have rented a locker at one of the locker banks. As described above, the locker banks may share vectors captured during the registration process so that each of the locker banks can recognized users who have rented a locker.

Similarly, each of the memories 120 includes an identification of the locker bank with which the vector is associated. For example, the identifier may identify the locker bank from which the vector is received. By including a relationship between the vector and the locker bank 110, users who attempt to retrieve items from an incorrect locker bank can be guided to the correct locker bank.

In some embodiments, multiple vectors may be mapped to the same locker identifier. In an example, multiple users may register for access to a rented locker. Accordingly, the vectors for each of the registered users may be associated with the rented locker, such as is shown in the locker bank 110a in the illustrated example.

In embodiments, the locker bank at which a user rents a locker stores the image of the user and an identifier of the locker that the user rented. As described above, the image may be used as a backup in the event of a malfunction with a locker bank 110; an administrator can use the image to identify users if the facial recognition does not work. Maintaining the identifier of the locker along with the other information associated with the rental allows the locker bank to identify unlock the appropriate locker when a user is identified.

In an example, the image is not shared with the other locker banks as the image is not necessary for the other locker banks to have the image to identify the users; the other locker banks can identify the user with the shared vector. Additionally, by not sharing the image, the risk of malicious actors acquiring the image is reduced.

In the illustrated embodiment, the locker identifiers are not shared between locker banks 110. In an example, because the vectors are associated with a locker bank identifier, the specific locker identifier is not necessary at the locker banks 110 at which the user does not have a rented locker; the locker banks 110 can use the locker bank identifier to identify where to direct users who attempt to retrieve items at the incorrect locker bank. In alternative embodiments, the locker identifier is shared between locker banks 110.

Although not shown for ease of illustration, the data maintained in the memories 120 may be encrypted. For example, the data may be encrypted with encryption at rest, such as by using the Advanced Encryption Standard algorithm (AES-256).

Similarly, while the illustrated example shows mappings between vectors and locker identifiers in the memories 120, in alternative embodiments, other identifiers may be used to identify users, and the memories 120 may include mappings between these identifiers and the locker identifiers. For example, as explained above, some users may use a passcode or a machine-readable code to access their rented lockers. Accordingly, in some embodiments, the memories 120 may store the passcode or the machine-readable code (or data encoded in the machine-readable code) in associated with the locker identifier.

As described above, data maintained in the memories 120 may be deleted after a user retrieves the stored items from the locker. For example, the data associated with the locker rental may be deleted immediately after the user retrieves the items. In another example, the data may be deleted after a buffer period (e.g., one hour after the user retrieves the stored items).

In other examples, users may rent lockers for specific time periods (e.g., a user may rent a locker for two hours or from 1:00 to 4:00 or for specific day(s)). In these examples, the data maintained in the memories 120 may be deleted at the end of the specified time periods, either immediately or after a buffer period.

In further examples, users may manually terminate a rental (e.g., by interacting with a display of the locker bank 110 to end the rental). In these examples, the data maintained in the memories 120 may be deleted after the user ends the rental, either immediately or after a buffer period.

In some embodiments, all of the data in the memories 120 of the locker banks may be deleted on a periodic schedule. For example, the data may be deleted at the end of every day.

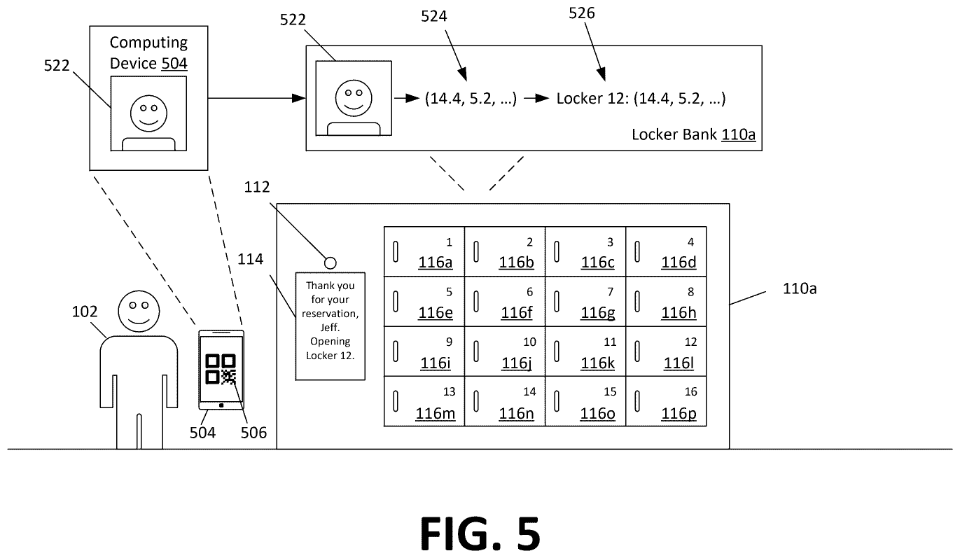

Turning to FIG. 5, an example of using a locker bank 110a with a reservation is shown. In embodiments, a user 102 may reserve a locker 116l in advance. For example, the user 102 may reserve the locker 116l before attending an amusement park. In an embodiment, the user may use a locker application executing on a mobile device 504 to reserve the locker 116l. While a mobile device 504 is shown in the illustrated embodiment, in alternative embodiments, the user may use any computing device to reserve the locker 116l.

In an embodiment, the user 102 may complete, or at least partially complete, a registration process in advance. For example, the user 102 may pay any rental fees for the locker 116l before interacting with the locker bank 110a. Additionally, the user 102 may capture an image to use for facial recognition before interacting with the locker bank 110a.

In an example, the user 102 may use the mobile device 504 to capture an image 522 of the user's 102 face. In embodiments in which the locker bank 110a performs liveness detection on users 102, the mobile device 504 may also perform liveness detection on the user 102 when capturing the image 522. For example, sensors on the mobile device 504 (e.g., an infrared sensor or a depth sensor) may be used to perform the liveness detection, similar to the locker bank 110a.

After the user 102 makes the reservation on the mobile device 504, the user can interact with the locker bank 110a to redeem the reservation and access the locker 116l. In an example, after completing the registration process, the user 102 may receive a machine-readable code 506 (e.g., a QR code) that the user 102 can present to the locker bank 110a to redeem the reservation. In an example, the machine-readable code 506 may encode information about the reservation, including the image 522 that was captured. The machine-readable code 506 may further encode information that the locker bank 110a can use to validate that the reservation is authentic. In alternative embodiments, the mobile device 504 may communicate information, such as the image 522, with the locker bank 110a in other ways, including wireless communication.

Because the image 522 and other data about the user 102 may not maintained at the locker bank 110a before the user 102 redeems the reservation, the risk that the information about the user 102 is stolen by malicious actors may be reduced; the locker bank 110a does not need to maintain the information other than during a period in which the user 102 is using the locker 116l.

After the locker bank 110a receives the image 522 and other any other data about the reservation, the locker bank 110a may process the image 522 as described above. The locker bank 110a may vectorize the image 522, and the vector 524 is stored with a mapping 526 to the rented locker. The user 102 may then be recognized by the locker bank 110a when the user 102 returns to retrieve stored items, as described above.

In alternative embodiments, some or all of the reservation information may be communicated to the locker bank 110a before the user 102 interacts with the locker bank 110a. In an example, reservation information may be communicated from the mobile device 504 to a central server, and the central server may communicate the information to the locker bank 110a. For example, the locker bank 110a may be informed that a locker 116l has been reserved before the user 102 interacts with the locker bank 110a so that the locker bank 110a can prevent the locker 116l from being rented by other users during the reservation time.

In an embodiment, the image 522 may be transmitted to the locker bank 110a before the user 102 interacts with the locker bank 110a. This may allow the locker bank 110a to recognize the user 102 to redeem the reservation without the user 102 needing to present the QR code 506 to the locker bank 110a or otherwise interact with the locker bank 110a to redeem the reservation. The locker bank 110a can capture an image of the user 102, determine that the captured image matches the image 522 from the reservation, and allow the user 102 to access the rented locker 116l. In an example, the image 522 is transferred to the locker bank 110a a short time before a time associated with the reservation (e.g., 15 minutes before the reservation). By transmitting the image 522 to the locker bank 110a shortly before the reservation, the locker bank 110a does not need to store the image 522 for an extended time period, reducing the risk of the image 522 being accessed by a malicious actor.

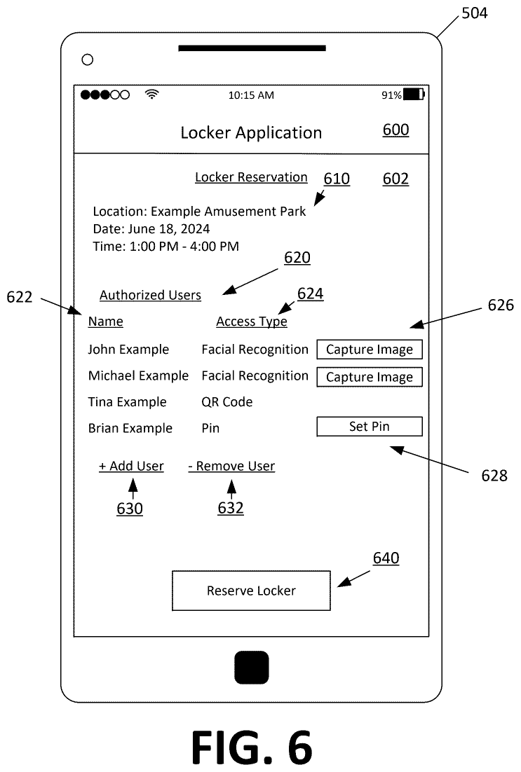

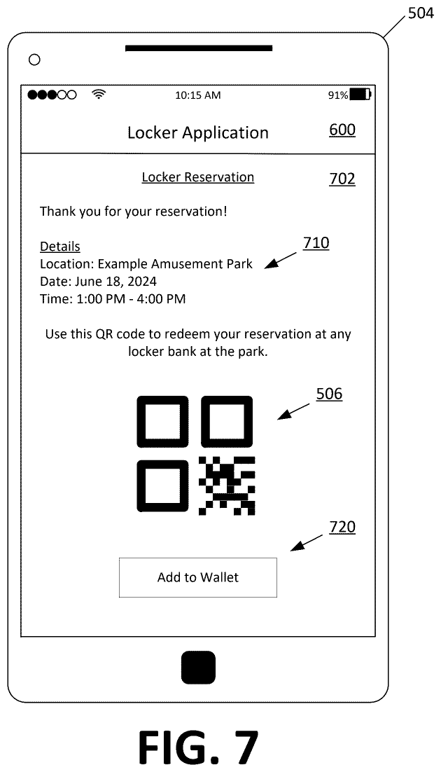

FIGS. 6 and 7 illustrate example user interfaces for reserving a locker at a locker bank. FIG. 6 illustrates a reservation user interface 602 in a locker application 600 executing on a mobile device 504. Although a mobile device 504 is shown in the illustrated embodiment, in alternative embodiments, the reservation user interface 602 may be presented on any computing device. In the illustrated example, the reservation user interface 602 includes reservation information 610 and authorized users 620.

The reservation information 610 includes information describing the location of the reservation as well as the date and time of the reservation. In an example, the reservation information 610 is entered by a user making the reservation. In some embodiments, the reservation information 610 includes additional information. For example, the reservation information 610 may specify a specific locker bank or a specific locker to be reserved.

The authorized users 620 include the users designated by the person making the reservation to have access to the reserved locker. Each of the authorized users may be identified by name 622, and an access type 624 may be specified for each user. As described above, users may be identified by locker banks using a number of methods including facial recognition, machine-readable codes (e.g., QR codes), and passcodes. In the illustrated example, the reservation user interface 602 includes options 626, 628 to capture information needed for the specified access types, such as options 626 to capture images of the users and an option 628 to set a passcode. The reservation user interface 602 also includes options 630, 632 to add and remove authorized users, respectively. Once the user is ready, the user can select an option 640 to reserve the locker.

FIG. 7 illustrates an example confirmation user interface 702. Like with the reservation user interface 602 described above in connection with FIG. 6, the confirmation user interface 702 may be presented in the locker application 600 executing on the mobile device 504. Although a mobile device 504 is shown in the illustrated embodiment, in alternative embodiments, the confirmation user interface 702 may be presented on any computing device.

In the illustrated example, the confirmation user interface 702 includes reservation information 710. The reservation information 710 may be the same information that was entered on the reservation user interface 602 described above with connection to FIG. 6. In an example, the reservation information 710 includes information describing the location of the reservation as well as the date and time of the reservation.

The confirmation user interface 702 may further include a machine-readable code 506 that can be scanned at a locker bank to redeem the reservation. In an example, the machine-readable code 506 encodes information about the reservation, including images captured of the authorized users and passcodes set by authorized users. In examples, the machine-readable code may additionally encode information to validate that the reservation is authentic. The confirmation user interface 702 may further include an option 720 to add the machine-readable code to a digital wallet of the mobile device 504.

While illustrated example shows a machine-readable code 506 that can be used to redeem the reservation at a locker bank, in alternative embodiments, other information may be presented in the confirmation user interface 702 that a user can use to redeem the reservation. For example, a confirmation code may be presented that the user can enter at a locker bank to redeem the reservation.

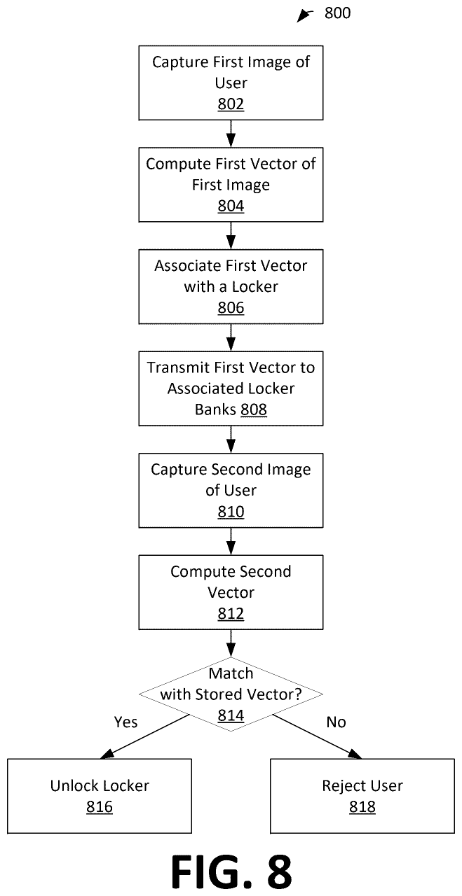

Turning to FIG. 8, a flowchart of an example method 800 for operating a facial recognition locker bank is shown. In an example, the method 800 may be performed to register a user renting a locker and automatically unlock the locker when the user returns to retrieve stored items. In the illustrated embodiment, the method 800 includes operations 802, 804, 806, 808, 810, 812, 814, 816, 818.

The operation 802 includes capturing a first image of a user. In an example, the user is a renting a locker at the locker bank, and the first image is captured during a registration process. In an embodiment, the first image includes a face of the user. In some embodiments, the operation 802 may further include performing liveness detection. In an embodiment, the first image is captured by a camera installed at the locker bank.

In alternative embodiments, the first image may be received by the locker bank in other ways. For example, as described above, users may reserve lockers in advance. In such examples, when the user reserves the locker, the user may capture an image using a mobile device or other computing device. The image captured by the mobile device may then be transmitted to the locker bank when the user redeems the reservation at the locker bank (e.g., by presenting a machine-readable code encoding the image to the locker bank).

The operation 804 includes computing a first vector of the first image. In an example, the vector is a feature vector for the first image. For example, the feature vector may include a height of the user's face, a width of the user's face, an average color of the face (in RGB colors), a width of the user's lips, and a height of the user's nose. In some embodiments, the operation 804 may include other processing of the first image to prepare the first image to be vectorized. For example, the first image may be cropped to center the user's face in the first image.

In an embodiment, a vectorizer computes the vector of the first image. In an example, the vectorizer includes a trained machine learning model, such as a neural network. In other embodiments, the vectorizer may include any machine learning or statistical model.

The operation 806 includes associating the first vector with a locker. In an example, the locker is being rented by the user. In an embodiment, the first vector is stored in a memory of the locker bank along with an identifier of the locker, as described above. In some embodiments, the first image may additionally be stored in the memory in association with the first vector and the locker identifier.

The operation 808 includes transmitting the first vector to associated locker banks. As described above, vectors computed by a locker bank may be shared with other locker banks so that the other locker banks can identify the user as well. In an embodiment, the first vector may be shared over a local area network to the associated locker banks using a network interface of the locker bank.

The operation 810 includes capturing a second image of the user. For example, the second image may be captured when the user returns to the locker bank to retrieve items stored in the rented locker. Like with the first image, the second image may include the face of the user. In an embodiment, the camera of the locker bank captures the second image of the user.

The operation 812 includes computing a second vector based on the second image. Like with the first vector, the second vector may be a feature vector of the second image and may include a height of the user's face, a width of the user's face, an average color of the face (in RGB colors), a width of the user's lips, and a height of the user's nose. Similarly, the second image may undergo other processing to prepare for the second vector to be computed (e.g., cropping the second image). In an embodiment, a vectorizer computes the second vector, similar to as described above with respect to the first vector.

The operation 814 includes comparing the second vector to other vectors stored at the locker bank, including the first vector. In an embodiment, cosine distances between the second vector and the other vectors. If the second vector matches one of the other vectors, the method 800 proceeds to the operation 816 and an associated locker is unlocked. For example, if the second vector matches the first vector, the locker rented by the user is unlocked. The association stored during the operation 806 may be used to identify the locker to be unlocked. In an example, vectors are considered to be matching if the cosine distance between the vectors is less than a predetermined distance. If the second vector does not match any of the stored vectors, the method 800 may proceed to the operation 818, and the user may be rejected.

In an embodiment, a facial recognition engine compares the second vector to other vectors stored at the locker bank. As described above, the facial recognition engine may use cosine distances to compare the vectors. In alternative example, the facial recognition engine may use any machine learning or statistical model to compare the vectors.

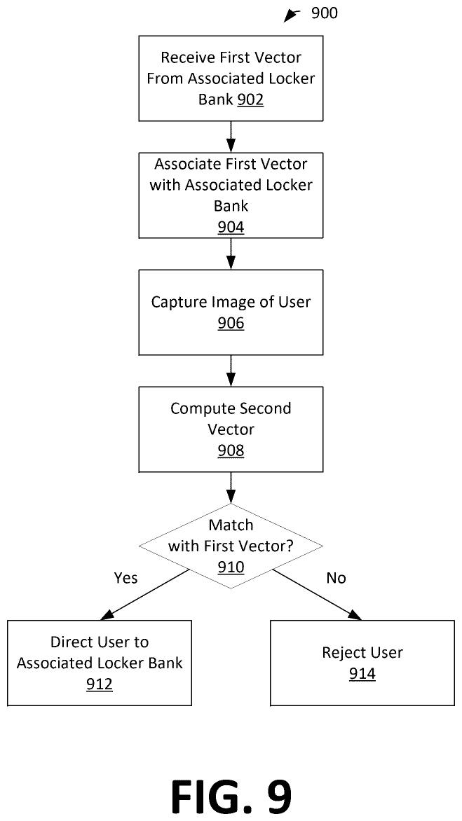

FIG. 9 illustrates a flowchart of another example method 900 for operating a facial recognition locker bank. In an example, the method 900 is performed to identify a user who rented a locker at an associated locker bank and direct the user to the correct locker bank to retrieve the user's stored items. In the illustrated embodiment, the method 900 includes operations 902, 904, 906, 908, 910, 912, 914.

The operation 902 includes receiving a first vector from an associated locker bank. In an example, the first vector is computed from an image of a user captured at the associated locker bank. In an example, the user rented a locker at the associated locker bank. As described above, the first vector may be a feature vector of the image captured by the associated locker bank. In an embodiment, the locker bank receives the first vector from the associated locker bank over a local area network using a network interface.

The operation 904 includes associating the first vector with the associated locker bank. In an example, the first vector is stored in a memory of the locker bank along with an identifier identifying the associated locker bank.

The operation 906 includes capturing an image of the user. In an example, the image is captured when the user attempts to retrieve items from a locker at the locker bank. As noted above, in this example, the user has items stored in the associated locker bank, not the locker bank at which the image is captured. In an embodiment, the image includes a face of the user. In embodiments, the image is captured by a camera at the locker bank.

The operation 908 includes computing a second vector of the image. As described above, the vector may be a feature vector of the image. In an embodiment, the second vector is computed by a vectorizer of the locker bank. In an example, the vectorizer includes a trained machine learning model to compute the second vector.

The operation 910 includes comparing the second vector with the first vector. In an example, the vectors are compared using a cosine distance between the vectors. In embodiments, a facial recognition engine compares the vectors.

If the cosine distance is less than a predetermined threshold, the vectors are determined to match. If the first vector and the second vector match, the method 900 proceeds to the operation 912, and the locker bank presents directions to direct the user to the associated locker bank at which the user rented a locker. In an embodiment, the directions are presented on a display at the locker bank.

If the cosine distance is greater than the predetermined threshold, the vectors are determined to not match. If the first vector and the second vector do not match, the method proceeds to the operation 914 and the user is rejected.

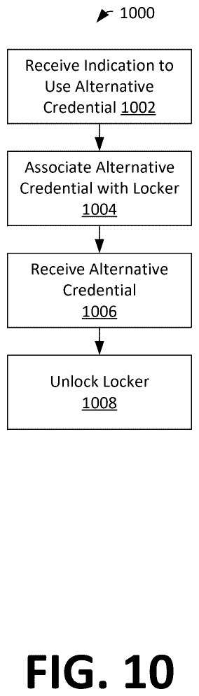

FIG. 10 illustrates a flowchart of a further example method 1000 for operating a facial recognition locker bank. In an example, the method 1000 is performed to register a user renting a locker at the locker bank and identify the user when the user returns to retrieve items stored in the rented locker. In this example, the user may choose to use a method other than facial recognition to be identified by the locker bank, such as by using a machine-readable code or a passcode. In the illustrated example, the method 1000 includes operations 1002, 1004, 1006, 1008.

The operation 1002 includes receiving an indication that a user wishes to use an alternative credential. Examples of alternative credentials include machine-readable codes (e.g., a QR code or a barcode) and passcodes. In an example, when renting a locker at the locker bank, the user may opt out of using facial recognition to identify the user and instead choose to use the alternative credential. In an embodiment, the user indicates that the user wishes to use the alternative credential during a registration process. In an example, the user may interact with a display presenting instructions for registration.

The operation 1004 includes associating the alternative credential with the rented locker. In an example, the alternative credential is stored in a memory of the locker bank along with an identifier of the rented locker.

The operation 1006 includes receiving the alternative credential from the user. In an example, the alternative credential is received when the user returns to the locker bank to retrieve items stored in the rented locker. For example, if the alternative credential is a machine-readable code, the locker bank may scan the machine-readable code using a camera or other scanner at the locker bank. In another example, if the alternative credential is a passcode, the user may interact with a display of the locker bank to input the passcode.

The operation 1008 includes unlocking the rented locker. In an example, if the alternative credential received during the operation 1006 is valid, the rented locker is unlocked so that the user can retrieve items stored in the rented locker.

Further aspects of the present disclosure are described in the following numbered clauses.
Clause 1: A facial recognition locker bank, comprising: one or more lockers; a camera; one or more processors; and one or more local computer-readable storage devices storing data instructions that, when executed by the one or more processors, cause the facial recognition locker bank to: capture, with the camera, a first image of a user, the first image including a face of the user; compute a first vector based on the first image; generate an association between the first vector and a locker of the one or more lockers; store, in the one or more local computer-readable storage devices, the association between the first vector and the locker of the one or more lockers; transmit the first vector to one or more associated locker banks; capture, with the camera, a second image of the user, the second image including the face of the user; compute a second vector based on the second image; compare the second vector to the first vector; and based on the comparison, unlock the locker associated with the first vector.
Clause 2: The facial recognition locker bank according to clause 1, wherein the data instructions further cause the facial recognition locker bank to: receive, from a second locker bank of the one or more associated locker banks, a third vector, wherein the third vector is associated with a second user; store, in the one or more local computer-readable storage devices, an association between the third vector and the second locker bank; capture, with the camera, a third image of the second user; compute a fourth vector based on the third image; compare the fourth vector to the third vector; and based on the comparison, present, via a display of the facial recognition locker bank, directions to the second locker bank.
Clause 3: The facial recognition locker bank according to clause 1, wherein the first vector is transmitted to the one or more associated locker banks over a local area network.
Clause 4: The facial recognition locker bank according to clause 1, wherein the data instructions further cause the facial recognition locker bank to: store, in the one or more local computer-readable storage devices, the first image of the user.
Clause 5: The facial recognition locker bank according to clause 1, wherein the data instructions further cause the facial recognition locker bank to: after unlocking the locker associated with the first vector, delete, from the one or more local computer-readable storage devices, the association between the first vector and the locker of the one or more lockers.
Clause 6: The facial recognition locker bank according to clause 5, wherein the association between the first vector and the locker of the one or more lockers is deleted immediately after unlocking the locker associated with the first vector.
Clause 7: The facial recognition locker bank according to clause 5, wherein the association between the first vector and the locker of the one or more lockers is deleted a predetermined amount of time after unlocking the locker associated with the first vector.
Clause 8: The facial recognition locker bank according to clause 1, wherein the data instructions further cause the facial recognition locker bank to: receive, from a second user, an indication to use an alternative credential; generate an association between the alternative credential and a second locker of the one or more lockers; store, in the one or more local computer-readable storage devices, the association between the alternative credential and the second locker; receive, from the second user, the alternative credential; and unlock the second locker associated with the alternative credential.
Clause 9: The facial recognition locker bank according to clause 8, wherein the alternative credential is a machine-readable code.
Clause 10: The facial recognition locker bank according to clause 8, wherein the alternative credential is a passcode.
Clause 11: A method for operating a facial recognition locker bank, the method comprising: capturing, with a camera of a locker bank, a first image of a user, the image including a face of the user; computing a first vector based on the first image; generating an association between the first vector and a locker of the locker bank; storing, in a local memory of the locker bank, the association between the first vector and the locker of the one or more lockers; transmitting the first vector to one or more associated locker banks; capturing, with the camera, a second image of the user, the second image including the face of the user; computing a second vector based on the second image; comparing the second vector to the first vector; and based on the comparison, unlocking the locker associated with the first vector.
Clause 12: The method according to clause 11, further comprising: receiving, from a second locker bank of the one or more associated locker banks, a third vector, wherein the third vector is associated with a second user; storing, in the local memory of the locker bank, an association between the third vector and the second locker bank; capturing, with the camera, a third image of the second user; computing a fourth vector based on the third image; comparing the fourth vector to the third vector; and based on the comparison, presenting, via a display of the locker bank, directions to the second locker bank.
Clause 13: The method according to clause 11, further comprising: after unlocking the locker associated with the first vector, deleting, from the local memory, the association between the first vector and the locker of the one or more lockers.
Clause 14: The method according to clause 11, further comprising: receiving, from a second user, an indication to use an alternative credential; generating an association between the alternative credential and a second locker; storing, in the local memory of the locker bank, the association between the alternative credential and the second locker; receiving, from the second user, the alternative credential; and unlocking the second locker associated with the alternative credential.
Clause 15: A facial recognition locker bank, comprising: one or more lockers; a camera; one or more processors; and one or more local computer-readable storage devices storing data instructions that, when executed by the one or more processors, cause the facial recognition locker bank to: receive, from a computing device of a user, a first image of the user, the first image including a face of the user; compute a first vector based on the first image; generate an association between the first vector and a locker of the one or more lockers; store, in the one or more local computer-readable storage devices, the association between the first vector and the locker of the one or more lockers; transmit the first vector to one or more associated locker banks; capture, with the camera, a second image of the user, the second image including the face of the user; compute a second vector based on the second image; compare the second vector to the first vector; and based on the comparison, unlock the locker associated with the first vector.
Clause 16: The facial recognition locker bank according to clause 15, wherein to receive, from a computing device of a user, a first image of the user includes to: scan a machine-readable code presented on the computing device, the machine-readable code encoding the first image.
Clause 17: The facial recognition locker bank according to clause 15, wherein the data instructions further cause the facial recognition locker bank to: capture, with the camera, a third image of a second user, the third image including a face of the second user; compute a third vector based on the third image; generate an association between the third vector and a second locker of the one or more lockers; store, in the one or more local computer-readable storage devices, the association between the third vector and the second locker of the one or more lockers; transmit the third vector to the one or more associated locker banks; capture, with the camera, a fourth image of the second user, the fourth image including the face of the second user; compute a fourth vector based on the fourth image; compare the fourth vector to the third vector; and based on the comparison, unlock the second locker associated with the third vector.
Clause 18: The facial recognition locker bank according to clause 15, wherein the data instructions further cause the facial recognition locker bank to: receive, from a second locker bank of the one or more associated locker banks, a third vector, wherein the third vector is associated with a second user; store, in the one or more local computer-readable storage devices, an association between the third vector and the second locker bank; capture, with the camera, a third image of the second user; compute a fourth vector based on the third image; compare the fourth vector to the third vector; and based on the comparison, present, via a display of the facial recognition locker bank, directions to the second locker bank.
Clause 19: The facial recognition locker bank according to clause 15, wherein the data instructions further cause the facial recognition locker bank to: after unlocking the locker associated with the first vector, delete, from the one or more local computer-readable storage devices, the association between the first vector and the locker of the one or more lockers.
Clause 20: The facial recognition locker bank according to clause 15, wherein the data instructions further cause the facial recognition locker bank to: receive, from a second user, an indication to use an alternative credential; generate an association between the alternative credential and a second locker of the one or more lockers; store, in the one or more local computer-readable storage devices, the association between the alternative credential and the second locker; receive, from the second user, the alternative credential; and unlock the second locker associated with the alternative credential.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A facial recognition locker bank, comprising:
one or more lockers;
a camera;
one or more processors; and
one or more local computer-readable storage devices storing data instructions that, when executed by the one or more processors, cause the facial recognition locker bank to:
capture, with the camera, a first image of a user, the first image including a face of the user;
compute a first vector based on the first image;
generate an association between the first vector and a locker of the one or more lockers;
store, in the one or more local computer-readable storage devices, the association between the first vector and the locker of the one or more lockers;
transmit the first vector to one or more associated locker banks;
capture, with the camera, a second image of the user, the second image including the face of the user;
compute a second vector based on the second image;
compare the second vector to the first vector; and
based on the comparison, unlock the locker associated with the first vector.

2. The facial recognition locker bank of claim 1, wherein the data instructions further cause the facial recognition locker bank to:
receive, from a second locker bank of the one or more associated locker banks, a third vector, wherein the third vector is associated with a second user;
store, in the one or more local computer-readable storage devices, an association between the third vector and the second locker bank;
capture, with the camera, a third image of the second user;
compute a fourth vector based on the third image;
compare the fourth vector to the third vector; and
based on the comparison, present, via a display of the facial recognition locker bank, directions to the second locker bank.

3. The facial recognition locker bank of claim 1, wherein the first vector is transmitted to the one or more associated locker banks over a local area network.

4. The facial recognition locker bank of claim 1, wherein the data instructions further cause the facial recognition locker bank to:
store, in the one or more local computer-readable storage devices, the first image of the user.

5. The facial recognition locker bank of claim 1, wherein the data instructions further cause the facial recognition locker bank to:
after unlocking the locker associated with the first vector, delete, from the one or more local computer-readable storage devices, the association between the first vector and the locker of the one or more lockers.

6. The facial recognition locker bank of claim 5, wherein the association between the first vector and the locker of the one or more lockers is deleted immediately after unlocking the locker associated with the first vector.

7. The facial recognition locker bank of claim 5, wherein the association between the first vector and the locker of the one or more lockers is deleted a predetermined amount of time after unlocking the locker associated with the first vector.

8. The facial recognition locker bank of claim 1, wherein the data instructions further cause the facial recognition locker bank to:
receive, from a second user, an indication to use an alternative credential;
generate an association between the alternative credential and a second locker of the one or more lockers;
store, in the one or more local computer-readable storage devices, the association between the alternative credential and the second locker;
receive, from the second user, the alternative credential; and
unlock the second locker associated with the alternative credential.

9. The facial recognition locker bank of claim 8, wherein the alternative credential is a machine-readable code.

10. The facial recognition locker bank of claim 8, wherein the alternative credential is a passcode.

11. A method for operating a facial recognition locker bank, the method comprising:
capturing, with a camera of a locker bank, a first image of a user, the image including a face of the user;
computing a first vector based on the first image;
generating an association between the first vector and a locker of the locker bank;
storing, in a local memory of the locker bank, the association between the first vector and the locker of the one or more lockers;
transmitting the first vector to one or more associated locker banks;
capturing, with the camera, a second image of the user, the second image including the face of the user;
computing a second vector based on the second image;
comparing the second vector to the first vector; and
based on the comparison, unlocking the locker associated with the first vector.

12. The method of claim 11, further comprising:
receiving, from a second locker bank of the one or more associated locker banks, a third vector, wherein the third vector is associated with a second user;
storing, in the local memory of the locker bank, an association between the third vector and the second locker bank;
capturing, with the camera, a third image of the second user;
computing a fourth vector based on the third image;
comparing the fourth vector to the third vector; and
based on the comparison, presenting, via a display of the locker bank, directions to the second locker bank.

13. The method of claim 11, further comprising:
after unlocking the locker associated with the first vector, deleting, from the local memory, the association between the first vector and the locker of the one or more lockers.

14. The method of claim 11, further comprising:
receiving, from a second user, an indication to use an alternative credential;
generating an association between the alternative credential and a second locker;
storing, in the local memory of the locker bank, the association between the alternative credential and the second locker;
receiving, from the second user, the alternative credential; and
unlocking the second locker associated with the alternative credential.

15. A facial recognition locker bank, comprising:
one or more lockers;
a camera;
one or more processors; and
one or more local computer-readable storage devices storing data instructions that, when executed by the one or more processors, cause the facial recognition locker bank to:
receive, from a computing device of a user, a first image of the user, the first image including a face of the user;
compute a first vector based on the first image;
generate an association between the first vector and a locker of the one or more lockers;
store, in the one or more local computer-readable storage devices, the association between the first vector and the locker of the one or more lockers;
transmit the first vector to one or more associated locker banks;
capture, with the camera, a second image of the user, the second image including the face of the user;
compute a second vector based on the second image;
compare the second vector to the first vector; and
based on the comparison, unlock the locker associated with the first vector.

16. The facial recognition locker bank of claim 15, wherein to receive, from a computing device of a user, a first image of the user includes to:
scan a machine-readable code presented on the computing device, the machine-readable code encoding the first image.

17. The facial recognition locker bank of claim 15, wherein the data instructions further cause the facial recognition locker bank to:
capture, with the camera, a third image of a second user, the third image including a face of the second user;
compute a third vector based on the third image;
generate an association between the third vector and a second locker of the one or more lockers;
store, in the one or more local computer-readable storage devices, the association between the third vector and the second locker of the one or more lockers;
transmit the third vector to the one or more associated locker banks;
capture, with the camera, a fourth image of the second user, the fourth image including the face of the second user;
compute a fourth vector based on the fourth image;
compare the fourth vector to the third vector; and
based on the comparison, unlock the second locker associated with the third vector.

18. The facial recognition locker bank of claim 15, wherein the data instructions further cause the facial recognition locker bank to:
receive, from a second locker bank of the one or more associated locker banks, a third vector, wherein the third vector is associated with a second user;
store, in the one or more local computer-readable storage devices, an association between the third vector and the second locker bank;
capture, with the camera, a third image of the second user;
compute a fourth vector based on the third image;
compare the fourth vector to the third vector; and
based on the comparison, present, via a display of the facial recognition locker bank, directions to the second locker bank.

19. The facial recognition locker bank of claim 15, wherein the data instructions further cause the facial recognition locker bank to:
after unlocking the locker associated with the first vector, delete, from the one or more local computer-readable storage devices, the association between the first vector and the locker of the one or more lockers.

20. The facial recognition locker bank of claim 15, wherein the data instructions further cause the facial recognition locker bank to:
receive, from a second user, an indication to use an alternative credential;
generate an association between the alternative credential and a second locker of the one or more lockers;
store, in the one or more local computer-readable storage devices, the association between the alternative credential and the second locker;
receive, from the second user, the alternative credential; and
unlock the second locker associated with the alternative credential.
